(19) United States
(12) Patent Application Publication
(10) Pub. No.: US 2026/0205800 A1
(43) Pub. Date: Jul. 16, 2026

(54) RENDEZVOUS POINT BASIC SERVICE SET IDENTIFIER BASED DISCOVERY FOR WIRELESS NETWORKS

(71) Applicant: Cisco Technology, Inc., San Jose, CA (US)

(72) Inventors: Jerome Henry, Pittsboro, NC (US); Javier Contreras, Barcelona (ES); Robert E. Barton, Richmond (CA); Domenico Ficara, Essertines-sur-Yverdon (CH)

(73) Assignee: Cisco Technology, Inc., San Jose, CA (US)

(21) Appl. No.: 19/448,862

(22) Filed: Jan. 14, 2026

Related U.S. Application Data
(60) Provisional application No. 63/745,121, filed on Jan. 14, 2025.

(51) Int. Cl. H04W 12/02; H04W 12/0431; H04W 12/06; H04W 60/04; H04W 76/10

(52) U.S. Cl. CPC H04W 12/02; H04W 12/0431; H04W 12/06; H04W 60/04; H04W 76/10

(57) ABSTRACT

Rendezvous point (RP) Basic Service Set Identifier (BSSID) based discovery for wireless networks may be provided. RP BSSID based discovery processes include transmitting, by a station (STA), an RP request addressed to a predefined RP BSSID corresponding to a RP access point (RPAP) within an access point (AP) cluster. The STA receives an RP response from the RPAP, wherein the RP response includes information enabling the STA to identify one or more BPE-enabled networks accessible through the AP cluster. The STA then establishes a connection with an AP in the AP cluster based on the information received in the RP response, wherein the connection operates with Basic Service Set (BSS) Privacy Enhancement (BPE) mechanisms enabled.

### RELATED APPLICATION

Under provisions of 35 U.S.C. § 119(e), Applicant claims the benefit of and priority to U.S. Provisional Application No. 63/745,121, filed January 14, 2025, the disclosure of which is incorporated herein by reference in its entirety.

### TECHNICAL FIELD

The present disclosure relates generally to providing rendezvous point (RP) Basic Service Set Identifier (BSSID) based discovery for wireless networks.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for rendezvous point (RP) Basic Service Set Identifier (BSSID) based discovery in accordance with aspects of the present disclosure.

FIG. 2 is a block diagram of the operating environment of FIG. 1 after a Station (STA) performs RP BSSID based discovery in accordance with aspects of the present disclosure.

FIG. 3 is a block diagram of an example formation of an AP cluster for RP BSSID based discovery in accordance with aspects of the present disclosure.

FIG. 4 is a signal diagram of an example RP BSSID based discovery process in accordance with aspects of the present disclosure.

FIG. 5 is a flow chart of a method for RP BSSID based discovery in accordance with aspects of the present disclosure.

FIG. 6 is a block diagram of a computing device in accordance with aspects of the present disclosure.

FIG. 7 is a block diagram of a communications device in accordance with aspects of the present disclosure.

### DETAILED DESCRIPTION

### OVERVIEW

Rendezvous point (RP) Basic Service Set Identifier (BSSID) based discovery for wireless networks may be provided. RP BSSID based discovery processes include transmitting, by a station (STA), an RP request addressed to a predefined RP BSSID corresponding to a RP access point (RPAP) within an access point (AP) cluster. The STA receives an RP response from the RPAP, wherein the RP response includes information enabling the STA to identify one or more BPE-enabled networks accessible through the AP cluster. The STA then establishes a connection with an AP in the AP cluster based on the information received in the RP response, wherein the connection operates with Basic Service Set (BSS) Privacy Enhancement (BPE) mechanisms enabled.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11bi draft standard is being developed for defining new mechanisms to improve user privacy in wireless networks (e.g., Wi-Fi networks). These Enhanced Data Privacy (EDP) mechanisms include Station (STA) (e.g., client device) specific mechanisms and network device mechanisms for various devices of the network, such as for the devices of a Basic Service Set (BSS). A BSS typically includes an Access Point (AP) and one or more associated STAs.

Mechanisms focused on enhancing STA privacy are designated as Client Privacy Enhancement (CPE). CPE mechanisms prevent the identification and tracking of STAs and are primarily coordinated and managed by the STA itself. CPE mechanisms enable STAs to obfuscate their identity, including their Media Access Control (MAC) address and other identifying elements.

Mechanisms that protect devices of an entire BSS (i.e., the AP and associated STAs) are designated as BSS Privacy Enhancements (BPE). BPE mechanisms prevent identification and tracking of the entire BSS and are coordinated and managed by APs and other network infrastructure devices, such as a Wireless Local Area Network (WLAN) controller or other network controller. BPE mechanisms enable APs to protect privacy by not transmitting discovery information (e.g., Service Set Identifier (SSID), capability elements, or operation elements) clearly over the air, not responding to legacy probe requests, and rotating the AP's MAC address and/or BSS identifier (BSSID).

In traditional wireless networks without privacy enhancements, STAs discover available networks through active or passive scanning. In passive scanning, STAs listen for beacon frames periodically broadcast by APs, which include the SSID, BSSID, and capability information. In active scanning, STAs broadcast probe request frames, and APs respond with probe response frames containing similar discovery information. However, BPE mechanisms fundamentally disrupt both discovery methods because BPE APs do not broadcast discovery information in beacon frames nor respond to legacy probe requests. Therefore, STAs cannot identify and connect to BPE-enabled networks using conventional discovery procedures.

In small-scale deployments, such as a virtual AP hosted on a client device, the STA may be pre-configured with parameters enabling the STA to discover the BPE-enabled AP. The provisioning can also occur out-of-band (OOB) (e.g., via short-range wireless communication). However, in larger-scale deployments, such as a public venue with a wireless network requiring both CPE and BPE (e.g., where the venue operator desires to provide network access to customers while preventing crowd-sourcing companies from easily mapping the venue), STAs need to be able to discover the network before enabling 802.11bi modes. Without a discovery mechanism, STAs cannot access BPE-enabled wireless networks. No existing solutions enable a STA to discover a network that implements both CPE and BPE mechanisms. As described herein, rendezvous point (RP) BSSID based discovery is implemented to enable STAs to discover such wireless networks.

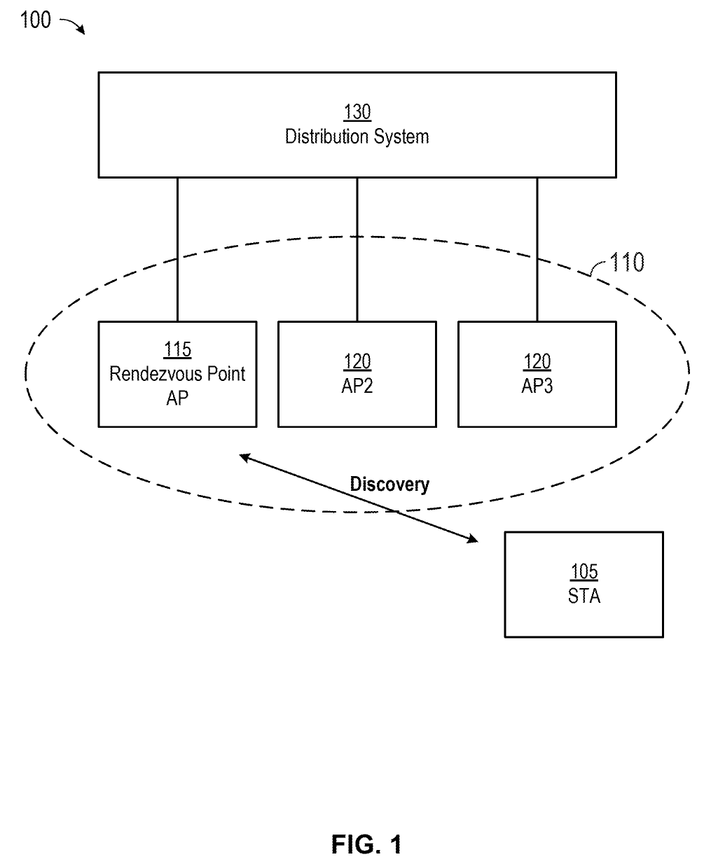

FIG. 1 is a block diagram of an operating environment 100 for RP BSSID based discovery. The operating environment 100 includes a STA 105, an AP cluster 110, and a distribution system (DS) 130. An AP cluster 110 comprises a rendezvous point AP (RPAP) 115 and zero or more additional APs 120. In the illustrated embodiment, the AP cluster further includes AP2 120 and AP3 120. The RPAP 115 and the APs 120 utilize BPE mechanisms as part of a BPE-enabled wireless network, so the STA 105 is unable to perform traditional active or passive scanning techniques to discover the network. The components of operating environment 100 cooperate to enable the STA 105 to discover and access the BPE-enabled wireless network using an RP BSSID based discovery mechanism.

The STA 105 is a client device seeking to discover and connect to a wireless network that implements BPE mechanisms. The STA 105 may be any wireless-enabled device, such as a smartphone, tablet, laptop computer, IoT device, or other computing device capable of wireless communication according to IEEE 802.11 standards. The STA 105 is configured to perform RP BSSID based discovery procedures to identify BPE-enabled networks that would otherwise be undiscoverable using conventional active or passive scanning methods. In certain embodiments, the STA 105 is a multi-link device (MLD) capable of simultaneously operating across multiple communication links, such as links operating on different frequency bands (e.g., 2.4 GHz, 5 GHz, 6 GHz) or different channels. As an MLD, the STA 105 may discover and establish connections with multiple APs or multiple links of a single AP MLD within the AP cluster 110.

The RPAP 115 is a specially configured AP within the AP cluster 110 that serves as a rendezvous point for STAs seeking to discover the BPE-enabled network. To maintain BPE privacy requirements, the RPAP 115 may not respond to legacy broadcast probe requests, not respond to unicast probe requests that mention a specific, non-802.11bi BSSID, and not transmit beacons. The RPAP 115 coordinates with the other APs 120 and the DS 130 to facilitate network discovery while maintaining privacy protections for the overall BSS.

In certain embodiments, the RPAP 115 is a MLD that operates across multiple communication links. As an MLD, the RPAP 115 may enable RP BSSID based discovery on one or more of its links. In example implementations, the RPAP 115 enables RP BSSID based discovery using a link operating on the 2.4 GHz frequency band because the 2.4 GHz band provides a wider coverage range than other frequency bands and ensures compatibility with STAs that scan the 2.4 GHz band first or exclusively during discovery procedures. After initial discovery on the 2.4 GHz band, the RPAP 115 may provide information about additional available links operating on other frequency bands (e.g., 5 GHz, 6 GHz) to support multi-link connectivity.

The APs 120 are additional APs within the AP cluster 110 that operate with BPE mechanisms enabled. These APs 120 provide wireless network access to authenticated and associated STAs while implementing privacy-enhancing features such as address rotation, restricted beacon information, and selective response to discovery requests. The APs 120 communicate with the RPAP 115 and the DS 130 to coordinate network operations and discovery procedures. In certain embodiments, one or more of the APs 120 are MLDs capable of operating across multiple communication links simultaneously. When configured as MLDs, the APs 120 can provide multi-link connectivity to MLD STAs (e.g., the STA 105) while maintaining BPE protections across all links.

The DS 130 is a network infrastructure component that interconnects the APs within the AP cluster 110 and may provide connectivity to external networks. The DS 130 may include or communicate with network management devices such as a WLAN controller or other network controller that coordinates BPE and CPE mechanisms across the AP cluster 110.

The AP cluster 110 is formed through conventional clustering mechanisms known in the art, wherein APs in physical proximity form an RF neighborhood based on overlapping coverage areas and signal propagation characteristics. APs 120 (including the RPAP 115) within the AP cluster 110 detect one another through beacon reception, neighbor discovery protocols, or coordination through the DS 130. The clustering may be managed automatically through distributed algorithms executed by the APs themselves, or centrally through a WLAN controller or network management system communicating via the DS 130. Factors influencing AP cluster 110 formation include RF signal strength between APs, physical distance, overlapping coverage areas, and administrative configuration. The formation of the AP cluster 110 follows these conventional practices, with the additional designation of one or more RPAPs 115 within the AP cluster 110 to support RP BSSID based discovery for the BPE-enabled network.

The RP BSSID based discovery process 400 generally operates as follows. To initiate RP BSSID based discovery, the STA 105 sends an RP probe request addressed to a predefined RP BSSID corresponding to the RPAP 115, also referred to as the rendezvous address. The RP BSSID is predefined to enable the STA 105 to direct discovery requests to the RPAP 115 and to enable the RPAP 115 to identify and respond to RP probe requests. In some embodiments, the RP BSSID comprises a specially formatted MAC address that includes a flag or indicator bit identifying it as a rendezvous point address. The STA 105 may obtain the predefined RP BSSID through pre-configuration, OOB provisioning, or through standardized assignment. When the STA 105 seeks to discover a BPE-enabled wireless network, the STA 105 transmits the RP probe request with the specific RP BSSID as the destination address. The RP probe request may include information indicating that the STA 105 seeks to discover BPE-enabled networks and may include capabilities, supported features, or credentials of the STA 105. One or more APs 120 in the AP cluster 110 may also receive the RP probe request but will not respond because they are not designated as the RPAP 115 and do not recognize the RP BSSID as their own address.

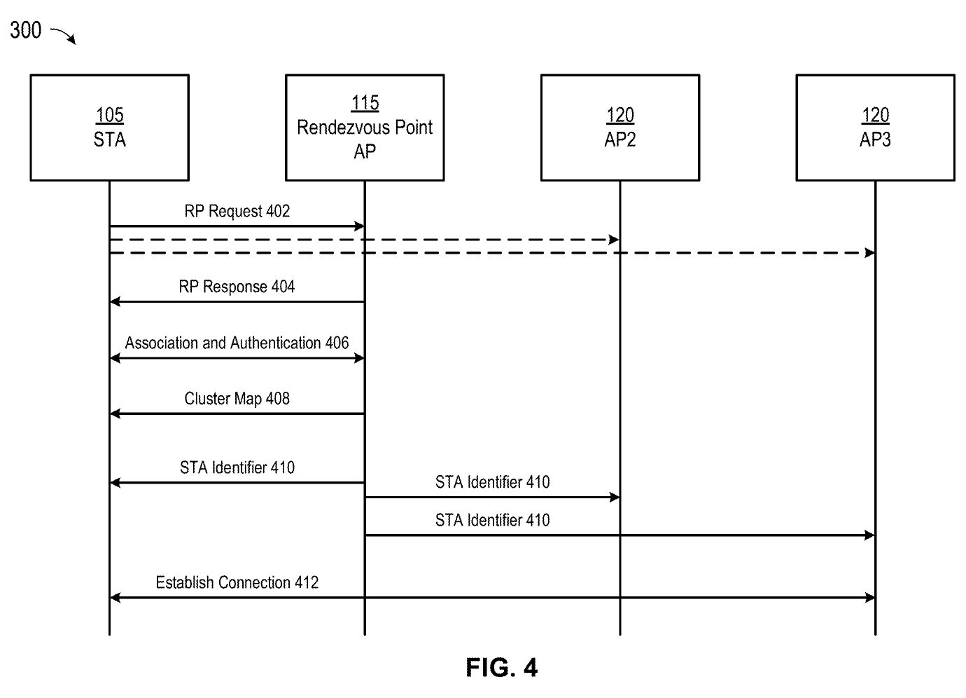

Upon receiving the RP probe request addressed to the RP BSSID, the RPAP 115 processes the request and generates an RP probe response. In some embodiments, the RPAP 115 determines whether the STA 105 is authorized to receive discovery information before generating and transmitting the RP probe response. The authorization determination may be based on credentials included in the RP probe request, the STA's MAC address, supported capabilities, or other authentication information. If the STA 105 is authorized (or if no authorization is required), the RPAP 115 generates the RP probe response including information about one or more BPE-enabled networks accessible through the AP cluster 110. The RP probe response may include encrypted or protected SSIDs, security parameters (e.g., authentication and encryption requirements), connection parameters, capability information, and/or identifiers for one or more of the APs 120 that the STA 105 may subsequently connect to. The RPAP 115 transmits the RP probe response to the STA 105. The STA 105 receives the RP probe response and extracts the network information, enabling the STA 105 to subsequently perform authentication and association procedures with one of the discovered BPE-enabled networks. The authentication and association procedures are described in further detail with respect to FIG. 4.

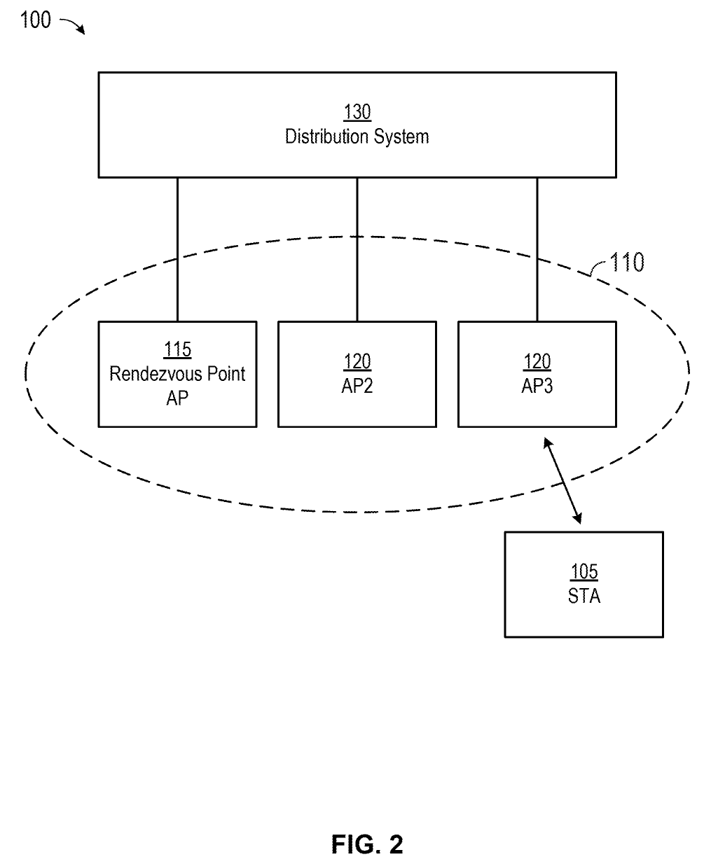

FIG. 2 is a block diagram of the operating environment 100 after the STA 105 performs RP BSSID based discovery. Following receipt of the RP probe response from the RPAP 115, the STA 105 obtains information necessary to authenticate and associate with one or more BPE-enabled APs 120 within the AP cluster 110. Using the network information provided in the RP probe response (such as encrypted SSIDs, security parameters, connection parameters, and AP identifiers), the STA 105 can connect to an AP in the cluster while operating in BPE mode for secure wireless network communication.

In the illustrated embodiment of FIG. 2, the STA 105 has authenticated and associated with AP3 120, establishing a wireless connection for data communication. The STA 105 selected AP3 120 based on the information provided by the RPAP 115 during the discovery process. The specific authentication and association procedures are described in further detail with respect to FIG. 4. In alternative embodiments, the STA 105 may authenticate and associate with the RPAP 115 itself rather than with one of the other APs 120 in the cluster. In still other embodiments, the STA 105 may authenticate and associate with a different AP 120 (e.g., AP2) depending on factors such as signal strength, load balancing, AP capabilities, or network policies. The RPAP 115 may include recommendations or instructions in the RP probe response to guide the STA's selection of which AP to connect to within the AP cluster 110.

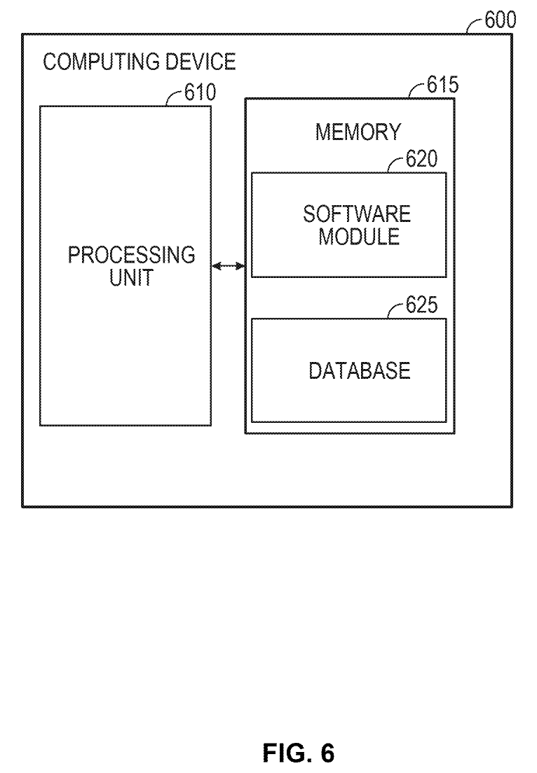

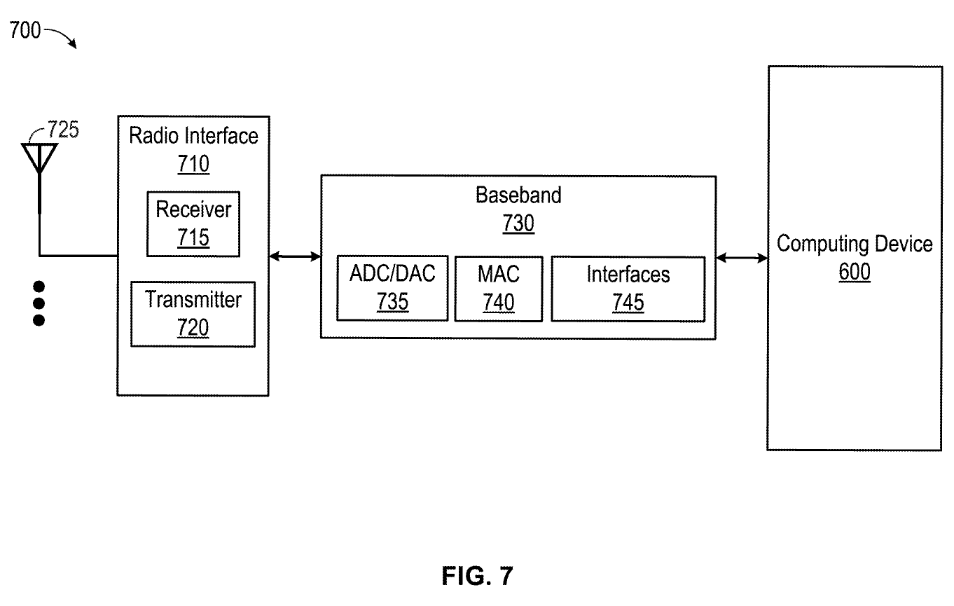

The elements described above of the operating environment 100 (e.g., the STA 105, the RPAP 115, the APs 120, the DS 130, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 6 and 7, the elements of the operating environment 100 may be practiced in a computing device 600 and/or communications device 700.

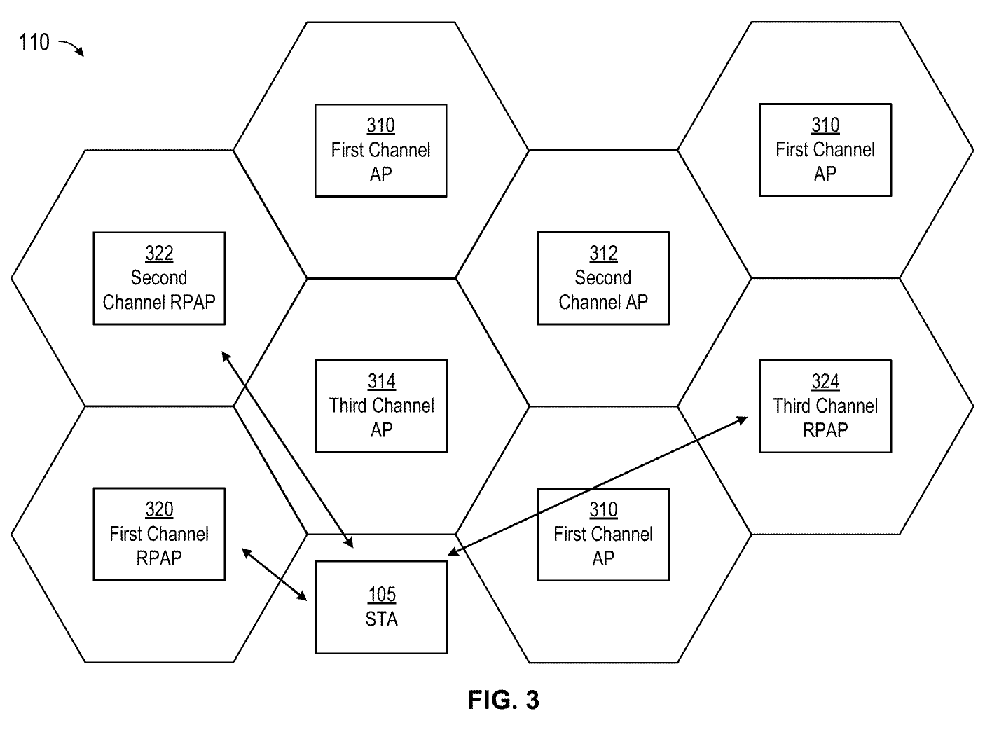

FIG. 3 is a block diagram of an example formation of the AP cluster 110 for RP BSSID based discovery. In certain embodiments, the AP cluster 110 includes multiple RPAPs 115, with one RPAP 115 designated for each active communication channel within the cluster. For example, in a deployment utilizing multiple 2.4 GHz channels (e.g., channels 1, 6, and 11), the AP cluster 110 may include three RPAPs 115, each operating on a different channel. This multi-RPAP architecture ensures that STAs 105 can discover BPE-enabled networks regardless of which channel they scan during discovery procedures. The remaining APs 120 within the AP cluster 110 are distributed across the available channels and operate with full BPE mechanisms enabled. The RPAPs 115 and APs 120 within the AP cluster 110 coordinate through the DS 130 to provide consistent network access and maintain privacy protections across all channels.

In the illustrated embodiment, the AP cluster 110 includes first channel APs 310 operating on a first 2.4 GHz channel, second channel APs 312 operating on a second 2.4 GHz channel, and third channel APs 314 operating on a third 2.4 GHz channel positioned to reduce co-channel interference. The AP cluster 110 includes a first channel RPAP 320, an RPAP 115 operating on the first 2.4 GHz channel. The AP cluster 110 further includes a second channel RPAP 322 (an RPAP 115 operating on the second 2.4 GHz channel) and a third channel RPAP 324 (an RPAP 115 operating on the third 2.4 GHz channel). The STA 105 can perform RP BSSID based discovery by sending an RP probe request to the first channel RPAP 320, the second channel RPAP 322, and/or the third channel RPAP 324. The closest RPAP 115 (e.g., the first channel RPAP 320) may respond to the request, the RPAP 115 operating on the same 2.4 GHz channel may respond to the request, and/or the like when multiple RPAPs 115 exist in the AP cluster 110.

FIG. 4 is a signal diagram of an example RP BSSID based discovery process 400. The process 400 demonstrates the message exchanges between the STA 105, the RPAP 115, and the APs 120 of the AP cluster 110 to enable the STA 105 to discover and connect to a BPE-enabled wireless network. The process 400 includes an RP request step 402, an RP response step 404, an association and authentication process step 406, a cluster map step 408, a STA identifier step 410, and a connection establishment process step 412

At step 402, the STA 105 transmits an RP request (e.g., an RP probe request) addressed to the RP BSSID corresponding to the RPAP 115. The RP request is a wireless transmission that may be received by multiple devices within RF range. In the illustrated embodiment, the RPAP 115 receives the RP request as the intended recipient. Additionally, AP2 120 and AP3 120 may also receive the RP request if they are within range to detect the transmission. However, as previously described, only the RPAP 115 will respond to the RP request because the other APs 120 do not recognize the RP BSSID as their own address and are not designated as rendezvous points.

At step 404, the RPAP 115 transmits an RP response to the STA 105. The RP response provides information that enables the STA 105 to identify networks of interest and determine available discovery and authentication mechanisms. The RP response is used by the STA 105 to learn possible SSID names of networks available in the AP cluster 110 and to determine whether Access Network Query Protocol (ANQP) support is available for those networks.

In some embodiments, the RP response includes only hashed SSID names rather than plaintext SSIDs. The hashed SSIDs maintain privacy while allowing the STA 105 to identify networks for which it has credentials by computing and comparing hash values. In other embodiments, the RP response includes one or more SSID values in plaintext or encrypted form, enabling the STA 105 to directly identify available networks and APs.

In certain embodiments, the RP response includes a flag associated with each BSSID to indicate support for Generic Advertisement Service (GAS) protocols, such as those used in IEEE 802.11u, OpenRoaming, or Passpoint implementations. When the flag indicates GAS support for a particular BSSID, the STA 105 may initiate a Pre-Association Security Negotiation (PASN) process with that BSSID to establish a protected channel for conducting a secure ANQP exchange. This enables the STA 105 to query network information (such as roaming consortiums, venue information, or network capabilities) in a privacy-protected manner before associating with the network.

In some embodiments, the RP response is formatted as a protected beacon frame rather than a conventional probe response. The protected beacon frame format provides enhanced security and privacy for the discovery information transmitted to the STA 105. When the STA 105 receives the RP response and identifies a network for which it has a pre-existing pre-shared identity key, valid credentials, or a stored profile, the STA 105 can proceed directly to association and authentication with the RPAP 115 using the RP BSSID address.

At step 406, the STA 105 and the RPAP 115 perform an association and authentication process. This process occurs when the STA 105 has identified a network for which it possesses authentication credentials, such as a pre-existing pre-shared identity key, valid credentials (e.g., username and password, certificate), or a stored network profile. The STA 105 initiates association with the RPAP 115 using the RP BSSID as the target address. Following successful association, the STA 105 and RPAP 115 complete an authentication exchange using the appropriate authentication method (e.g., WPA2, WPA3, 802.1X, SAE). The association and authentication process establishes an authenticated, trusted, and protected communication channel between the STA 105 and the RPAP 115. This protected channel enables secure transmission of sensitive network information in subsequent steps.

At step 408, the RPAP 115 transmits a cluster map to the STA 105 over the protected connection established in step 406. The cluster map provides the STA 105 with information about the BPE-enabled network topology in the local RF area (e.g., the AP cluster 110), enabling the STA 105 to identify available APs for subsequent connection. In some embodiments, the cluster map is formatted as a Reduced Neighbor Report (RNR) element that includes information about neighboring APs and their BSSIDs. In other embodiments, the cluster map is formatted as a protected IEEE 802.11k neighbor report that provides detailed information about neighboring APs within the AP cluster 110. The cluster map may include information about multiple physical AP devices within the AP cluster 110, or it may describe only the RPAP 115 itself if the RPAP 115 operates as a multi-link or multi-BSSID device. The cluster map includes protected BSSIDs for the neighboring APs (i.e., the actual BSSIDs used by BPE-enabled APs 120 for operational communications, as distinct from the RP BSSID used for discovery), as well as security information and policy information for each AP. The security information may include supported authentication methods, encryption algorithms, and security capabilities. The policy information may include access policies, quality of service parameters, load information, or connection preferences.

At step 410, the RPAP 115 transmits a STA identifier to both the STA 105 and the APs 120 within the AP cluster 110. The STA identifier enables the STA 105 to subsequently associate with BPE-enabled APs 120 in the AP cluster 110 by providing an identifier that is known and accepted by those APs. Without such an identifier, the BPE-enabled APs 120 would not respond to or accept connections from the STA 105 due to their privacy-protecting operational mode. The device identifier may serve as a credential or token that the STA 105 can present to BPE-enabled APs 120 to prove that it has been authorized through the discovery process. In some embodiments, the RPAP 115 generates the device identifier for the STA 105 and transmits this identifier to the STA 105 over a protected management frame. The RPAP 115 may transmit the protected management frame over the secure connection established in step 406 in example implementations. The device identifier may be generated using methods defined in IEEE 802.11bh or other suitable identifier generation mechanisms. The RPAP 115 may share the device identifier with the APs 120 via the DS 130 or through direct inter-AP communication.

In certain embodiments, the RPAP 115 implements CPE mechanisms in conjunction with BPE mechanisms. After the STA 105 associates with the RPAP 115 in step 406, the STA 105 and the RPAP 115 may negotiate and agree upon a STA MAC address rotation scheme as part of CPE procedures. The MAC address rotation scheme defines parameters such as rotation timing, the method for generating rotated MAC addresses, synchronization mechanisms, and the scope of addresses to be used. The RPAP 115 then shares the agreed-upon MAC address rotation scheme with the neighboring BPE-enabled APs 120 in the cluster, enabling the APs 120 to recognize and accept connections from the STA 105 as it rotates through different MAC addresses. This coordinated privacy protection is provided for both the STA 105 through MAC address rotation and the network infrastructure through BPE mechanisms.

At step 412, the STA 105 performs a connection establishment process with one of the APs 120 in the AP cluster 110, illustrated as AP3 120. The purpose of the RPAP 115 is to enable the STA 105 to discover BPE-enabled networks and obtain the necessary credentials and network information so an AP 120 can provide full data communication services to the STA 105. However, the STA 105 may determine to connect with the RPAP 115 for full communication services in example implementations (e.g., when the RPAP 115 is the closest AP and/or can provide the best connection of the devices in the AP cluster 110). Once the STA 105 receives the cluster map and the STA identifier, the STA 105 has obtained all information necessary to discover and connect to the neighboring BPE-enabled APs 120 in the AP cluster 110. The STA 105 then establishes a connection with one of the APs (the RPAP 115 or an AP 120) operating in full IEEE 802.11bi mode.

To establish the connection with AP3 120, the STA 105 uses the information provided in the cluster map to identify AP3 120 and obtain its protected BSSID and connection parameters. The STA 105 then initiates any necessary association and authentication procedures with AP3 120 according to the procedures defined in the IEEE 802.11bi standard, presenting the STA identifier received from the RPAP 115 to prove its authorization. Upon successful authentication and association, the STA 105 establishes a data communication connection with AP3 120 for transmitting and receiving network traffic. The STA 105 and AP3 120 operate in BPE mode, implementing privacy-enhancing mechanisms such as address rotation and restricted information disclosure.

The RP BSSID based discovery process 400 thereby enables a STA 105 to enter a new venue or RF area, discover BPE-enabled networks that would otherwise be hidden from conventional discovery procedures, authenticate with a rendezvous point, receive necessary network topology and credential information, and establish a connection with a BPE-enabled AP to communicate via the wireless network while maintaining privacy protections for both the STA 105 and the network infrastructure.

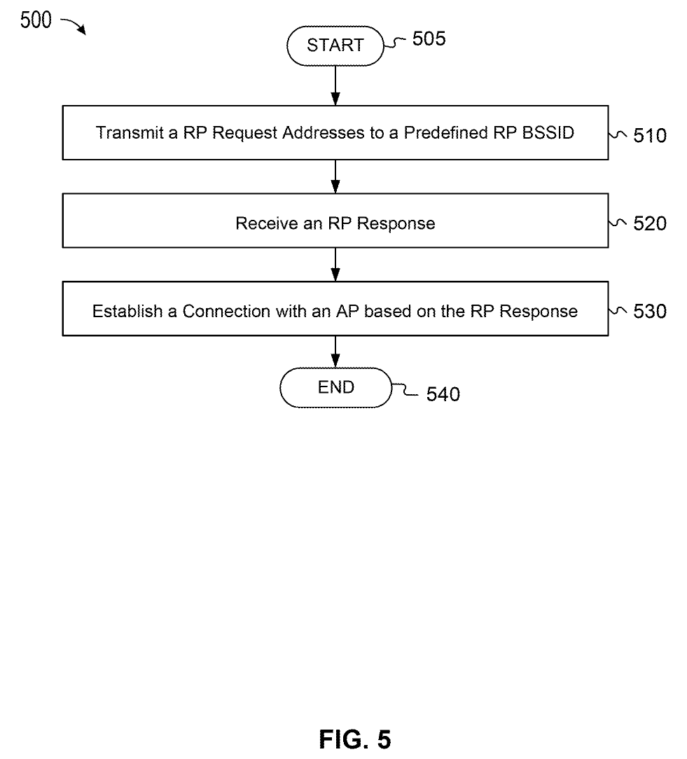

FIG. 5 is a flow chart of a method 500 for RP BSSID based discovery. The method 500 may begin at starting block 505 and proceed to operation 510. In operation 510, the STA 105 transmits a RP request addressed to a predefined RP BSSID. The RP BSSID corresponds to a RPAP 115 within an AP cluster 110.

In operation 520, the STA 105 receives an RP response from the RPAP 115. The RP response includes information enabling the STA 105 to identify one or more BPE-enabled networks accessible through the AP cluster 110. The RP response can include one or more hashed SSID values corresponding to available networks or one or more SSID values corresponding to the available networks. In some embodiments, the RP response includes one or more BSSIDs corresponding to available APs and a flag associated with the BSSIDs indicating whether the available APs support generic advertisement service GAS protocols. The STA 105 can initiate a PASN process with a BSSID having GAS support to conduct a protected ANQP exchange.

In operation 530, the STA 105 establishes a connection with an AP 120 in the AP cluster 110 based on the information received in the RP response. The connection operates with BPE mechanisms enabled in example implementations.

In some embodiments, the method 500 further includes associating and authenticating, by the STA 105, with the RPAP 115 using the predefined RP BSSID when the STA 105 has a pre-existing pre-shared identity key or valid credentials for an identified network; and establishing, through the association and authentication, a protected communication channel between the STA 105 and the RPAP 115. The method 500 can also include receiving, by the STA 105, a cluster map from the RPAP 115 over the protected communication channel, wherein the cluster map includes information about BPE-enabled APs 120 within the AP cluster 110.

In some embodiments, the method 500 includes receiving, by the STA 105, a STA identifier from the RPAP 115 over a protected management frame, wherein the STA identifier comprises a device identifier identifying the STA 105 and/or a MAC address rotation scheme of the STA 105. Establishing the connection with the AP 120 in the AP cluster 110 can include presenting the STA identifier to authenticate the STA 105 to the AP 120. The method 500 may further comprise receiving a cluster map from the RPAP 115, wherein the cluster map includes information about BPE-enabled APs 120 within the AP cluster 110. Establishing the connection with the AP 120 in the AP cluster 110 can include identifying, by the STA 105, a target AP 120 from the cluster map and switching the connection from the RPAP 115 to the target AP 120 and presenting the STA identifier. The method 500 concludes at ending block 540.

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for RP BSSID based discovery with respect to FIGS. 1-5. Computing device 600, for example, may provide an operating environment for the STA 105, the RPAP 115, the APs 120, the DS 130, and the like. The STA 105, the RPAP 115, the APs 120, the DS 130, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 600 on the single integrated circuit (chip).

FIG. 7 illustrates an implementation of a communications device 700 that may implement one or more of the STA 105, the RPAP 115, the APs 120, the DS 130, etc., of FIGS. 1-5. In various implementations, the communications device 700 may comprise a logic circuit. The logic circuit may include physical circuits to perform operations described for one or more of the STA 105, the RPAP 115, the APs 120, the DS 130, etc., of FIGS. 1-5, for example. As shown in FIG. 7, the communications device 700 may include one or more of, but is not limited to, a radio interface 710, baseband circuitry 730, and/or the computing device 600.

The communications device 700 may implement some or all of the structures and/or operations the STA 105, the RPAP 115, the APs 120, the DS 130, etc., of FIGS. 1-5, storage medium, and logic circuit in a single computing entity, such as entirely within a single device. Alternatively, the communications device 700 may distribute portions of the structure and/or operations using a distributed system architecture, such as a client station server architecture, a peer-to-peer architecture, a master-slave architecture, etc.

A radio interface 710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 710 may include, for example, a receiver 715 and/or a transmitter 720. The radio interface 710 may include bias controls, a crystal oscillator, and/or one or more antennas 725. In additional or alternative configurations, the radio interface 710 may use oscillators and/or one or more filters, as desired.

The baseband circuitry 730 may communicate with the radio interface 710 to process, receive, and/or transmit signals and may include, for example, an Analog-To-Digital Converter (ADC) for down converting received signals with a Digital-To-Analog Converter (DAC) 735 for up converting signals for transmission. Further, the baseband circuitry 730 may include a baseband or PHYsical layer (PHY) processing circuit for the PHY link layer processing of respective receive/transmit signals. Baseband circuitry 730 may include, for example, a MAC processing circuit 740 for MAC/data link layer processing. Baseband circuitry 730 may include a memory controller for communicating with MAC processing circuit 740 and/or a computing device 600, for example, via one or more interfaces 745.

In some configurations, PHY processing circuit may include a frame construction and/or detection module, in combination with additional circuitry such as a buffer memory, to construct and/or deconstruct communication frames. Alternatively or in addition, MAC processing circuit 740 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
transmitting, by a station (STA), a rendezvous point (RP) request addressed to a predefined RP Basic Service Set Identifier (BSSID), wherein the predefined RP BSSID corresponds to a RP access point (RPAP) within an access point (AP) cluster;
receiving, by the STA, an RP response from the RPAP, wherein the RP response includes information enabling the STA to identify one or more BPE-enabled networks accessible through the AP cluster; and
establishing, by the STA, a connection with an AP in the AP cluster based on the information received in the RP response, wherein the connection operates with Basic Service Set (BSS) Privacy Enhancement (BPE) mechanisms enabled.

2. The method of claim 1, wherein the RP response comprises any one of (i) one or more hashed Service Set Identifier (SSID) values corresponding to available networks, or (ii) one or more SSID values corresponding to the available networks.

3. The method of claim 1, wherein:
the RP response comprises:
one or more BSSIDs corresponding to available APs, and
a flag associated with the BSSIDs indicating whether the available APs support generic advertisement service (GAS) protocols; and
the method further comprises initiating, by the STA, a pre-association security negotiation (PASN) process with a BSSID having GAS support to conduct a protected access network query protocol (ANQP) exchange.

4. The method of claim 1, further comprising:
associating and authenticating, by the STA, with the RPAP using the predefined RP BSSID when the STA has a pre-existing pre-shared identity key or valid credentials for an identified network; and
establishing, through the association and authentication, a protected communication channel between the STA and the RPAP.

5. The method of claim 4, further comprising:
receiving, by the STA, a cluster map from the RPAP over the protected communication channel, wherein the cluster map includes information about BPE-enabled APs within the AP cluster.

6. The method of claim 1, further comprising:
receiving, by the STA, a STA identifier from the RPAP over a protected management frame, wherein the STA identifier comprises any one of (i) a device identifier identifying the STA, (ii) a MAC address rotation scheme of the STA, or (iii) both (i) and (ii); and
wherein establishing the connection with the AP in the AP cluster comprises presenting the STA identifier to authenticate the STA to the AP.

7. The method of claim 6, further comprising:
receiving a cluster map from the RPAP, wherein the cluster map includes information about BPE-enabled APs within the AP cluster;
wherein establishing the connection with the AP in the AP cluster comprises:
identifying, by the STA, a target AP from the cluster map, and
switching the connection from the RPAP to the target AP and presenting the STA identifier.

8. A system comprising:
a memory storage; and
a processing unit coupled to the memory storage, wherein the processing unit is operative to:
transmit a rendezvous point (RP) request addressed to a predefined RP Basic Service Set Identifier (BSSID), wherein the predefined RP BSSID corresponds to a RP access point (RPAP) within an access point (AP) cluster;
receive an RP response from the RPAP, wherein the RP response includes information enabling the system to identify one or more BPE-enabled networks accessible through the AP cluster; and
establish a connection with an AP in the AP cluster based on the information received in the RP response, wherein the connection operates with Basic Service Set (BSS) Privacy Enhancement (BPE) mechanisms enabled.

9. The system of claim 8, wherein the RP response comprises any one of (i) one or more hashed Service Set Identifier (SSID) values corresponding to available networks, or (ii) one or more SSID values corresponding to the available networks.

10. The system of claim 8, wherein:
the RP response comprises:
one or more BSSIDs corresponding to available APs, and
a flag associated with the BSSIDs indicating whether the available APs support generic advertisement service (GAS) protocols; and
the processing unit is further operative to initiate a pre-association security negotiation (PASN) process with a BSSID having GAS support to conduct a protected access network query protocol (ANQP) exchange.

11. The system of claim 8, the processing unit being further operative to:
associate and authenticate with the RPAP using the predefined RP BSSID when the system has a pre-existing pre-shared identity key or valid credentials for an identified network; and
establish, through the association and authentication, a protected communication channel between the system and the RPAP.

12. The system of claim 11, the processing unit being further operative to:
receive a cluster map from the RPAP over the protected communication channel, wherein the cluster map includes information about BPE-enabled APs within the AP cluster.

13. The system of claim 8, the processing unit being further operative to:
receive a STA identifier from the RPAP over a protected management frame, wherein the STA identifier comprises any one of (i) a device identifier identifying the system, (ii) a MAC address rotation scheme of the system, or (iii) both (i) and (ii); and
wherein establishing the connection with the AP in the AP cluster comprises presenting the STA identifier to authenticate the system to the AP.

14. The system of claim 13, the processing unit being further operative to:
receive a cluster map from the RPAP, wherein the cluster map includes information about BPE-enabled APs within the AP cluster;
wherein establishing the connection with the AP in the AP cluster comprises:
identifying a target AP from the cluster map, and
switching the connection from the RPAP to the target AP and presenting the STA identifier.

15. A non-transitory computer-readable medium that stores a set of instructions which when executed perform a method executed by the set of instructions comprising:
transmitting a rendezvous point (RP) request addressed to a predefined RP Basic Service Set Identifier (BSSID), wherein the predefined RP BSSID corresponds to a RP access point (RPAP) within an access point (AP) cluster;
receiving an RP response from the RPAP, wherein the RP response includes information enabling identification of one or more BPE-enabled networks accessible through the AP cluster; and
establishing a connection with an AP in the AP cluster based on the information received in the RP response, wherein the connection operates with Basic Service Set (BSS) Privacy Enhancement (BPE) mechanisms enabled.

16. The non-transitory computer-readable medium of claim 15, wherein:
wherein the RP response comprises any one of (i) one or more hashed Service Set Identifier (SSID) values corresponding to available networks, or (ii) one or more SSID values corresponding to the available networks.

17. The non-transitory computer-readable medium of claim 15, wherein:
the RP response comprises:
one or more BSSIDs corresponding to available APs, and
a flag associated with the BSSIDs indicating whether the available APs support generic advertisement service (GAS) protocols; and
the method executed by the set of instructions further comprises initiating a pre-association security negotiation (PASN) process with a BSSID having GAS support to conduct a protected access network query protocol (ANQP) exchange.

18. The non-transitory computer-readable medium of claim 15, the method executed by the set of instructions further comprising:
associating and authenticating with the RPAP using the predefined RP BSSID when there is a pre-existing pre-shared identity key or valid credentials for an identified network; and
establishing, through the association and authentication, a protected communication channel with the RPAP.

19. The non-transitory computer-readable medium of claim 18, the method executed by the set of instructions further comprising:
receiving a cluster map from the RPAP over the protected communication channel, wherein the cluster map includes information about BPE-enabled APs within the AP cluster.

20. The non-transitory computer-readable medium of claim 15, the method executed by the set of instructions further comprising:
receiving a STA identifier from the RPAP over a protected management frame, wherein the STA identifier comprises any one of (i) a device identifier, (ii) a MAC address rotation scheme, or (iii) both (i) and (ii); and
wherein establishing the connection with the AP in the AP cluster comprises presenting the STA identifier to authenticate to the AP.
